(19) United States
(12) Patent Application Publication
(10) Pub. No.: US 2007/0206100 A1
(43) Pub. Date: Sep. 6, 2007

(54) VIDEO MONITORING SYSTEM AND VIDEO MONITORING PROGRAM

(75) Inventor: Jun Hikita, Kanagawa (JP)

Correspondence Address: BELL, BOYD & LLOYD, LLP, P. O. BOX 1135, CHICAGO, IL, 60690, US

(73) Assignee: SONY CORPORATION, Tokyo (JP)

(21) Appl. No.: 11/681,601

(22) Filed: Mar. 2, 2007

(30) Foreign Application Priority Data
Mar. 6, 2006 (JP) P2006-059025

(51) Int. Cl. H04N 5/232; G09G 5/08; H04N 5/225; G06F 3/033

(52) U.S. Cl. 348/211.7; 348/207.11; 345/161

(57) ABSTRACT

A video monitoring system includes a camera connected to a network; a recording unit recording, via the network, video images captured by the camera; a display unit displaying video images captured by the camera; a control unit controlling display of video images on the display means; and a joystick controller changing the operation of a joystick according to a control mode selected by the control unit. The joystick controller performs control such that when the joystick controller is controlled in a camera control mode by the control unit, a video capturing operation of the camera is controllable with the joystick, and when the joystick controller is controlled in a function setting mode by the control unit, the operation of a pointer displayed on the display unit or selecting operation for selecting a list item is controllable with the joystick.

### CROSS REFERENCES TO RELATED APPLICATIONS

The present application claim priority to Japanese Patent Application JP 2006-059025 filed in the Japanese Patent Office on Mar. 6, 2006, the entire contents of which are incorporated herein by reference.

### BACKGROUND

The present application relates to a video monitoring system capable of displaying, recording, and playing back video images captured by cameras connected to a network, and further relates to a video monitoring program executed by the video monitoring system. In particular, the present invention relates to a video monitoring system having a function of controlling a joystick used to control camera operations, and further relates to a video monitoring program executed by the video monitoring system.

A video monitoring system is a system, for example, for displaying video images captured by a plurality of cameras on a monitor in a split screen format, simultaneously monitoring video images of different locations at one place, recording the captured video images, and playing back the recorded video images as necessary. Recently, to improve security, video monitoring is carried out not only in banks and convenience stores, but also in various other places, such as general offices, parking lots, streets, schools, condominiums, and private residences (see, e.g., Japanese Unexamined Patent Application Publication Nos. 2001-309368 and 10-336631).

At the same time, with the development of network technology as well as with recent trends toward higher-performance and less-expensive cameras capable of capturing video images and larger-capacity and less-expensive recording media, the emergence of network-capable video monitoring systems that can manage display, storage, and playback of video images transmitted via a network from a plurality of cameras connected to the network has been seen.

In such a video monitoring system, video images transmitted from a plurality of cameras can be simultaneously displayed on a monitor. A user can control the shooting operation of each camera by remote control so as to capture video images at desired angles. For the remote control, the user operates dedicated buttons provided on the video monitoring system or a joystick attached to the video monitoring system as a remote control unit.

However, in such a known video monitoring system, a joystick provided as a remote control unit is typically used to control pan/tilt/zoom functions of each camera, and is not used to perform various functions of the video monitoring system. In other words, although camera control can be performed using the joystick, the user has to take his/her hand off the joystick and press other function buttons to select various functions and settings of the video monitoring system. This means that the convenience of joystick operation is not yet fully being realized.

### SUMMARY

According to an embodiment, there is provided a camera connected to a network; a recording unit recording, via the network, video images captured by the camera; a display unit displaying video images captured by the camera; a control unit controlling display of video images on the display means; and a joystick controller changing the operation of a joystick according to a control mode selected by the control unit. The joystick controller performs control such that when the joystick controller is controlled in a camera control mode by the control unit, a video capturing operation of the camera is controllable with the joystick, and when the joystick controller is controlled in a function setting mode by the control unit, the operation of a pointer displayed on the display unit or selecting operation for selecting a list item is controllable with the joystick.

Additionally, in a video monitoring program executed by the video monitoring system described above, control is performed such that when the joystick controller is controlled in a camera control mode by program processing carried out by the control unit, a video capturing operation of the camera is controllable with the joystick, and when the joystick controller is controlled in a function setting mode by program processing carried out by the control unit, the operation of a pointer displayed on the display unit or selecting operation for selecting a list item is controllable with the joystick.

According to the embodiment described above, since the function of the joystick can be changed by the joystick controller according to the device's operation mode set by the control unit, the joystick can be used for purposes other than camera control. That is, in camera control mode, the user can control video capturing operation (e.g., panning, tilting, or zooming) of a camera as in the case of typical joystick operation, while in function setting mode, the user can move a pointer displayed on the display unit and select a list item by operating the joystick so as to select and set various functions.

Therefore, the user can not only perform camera control, but also perform pointer control and list-item selection control and thus can achieve various control operations without taking his/her hand off the joystick. This can reduce key operations performed by the user and greatly improve operability.

Additional features and advantages are described herein, and will be apparent from, the following Detailed Description and the figures.

### BRIEF DESCRIPTION OF THE FIGURES

FIG. 1 is schematic diagram illustrating a configuration of a video monitoring system according to an embodiment.

FIG. 2 is a schematic diagram illustrating a configuration of a video monitoring program according to the embodiment.

FIG. 3 illustrates a display example in which video images captured by a plurality of cameras are displayed on a monitor.

FIG. 4 is a schematic diagram illustrating a remote control unit.

FIG. 5 is a schematic diagram illustrating a first example of joystick operation.

FIG. 6 is a second schematic diagram illustrating a second example of joystick operation.

FIG. 7 is a third schematic diagram illustrating a third example of joystick operation.

### DETAILED DESCRIPTION

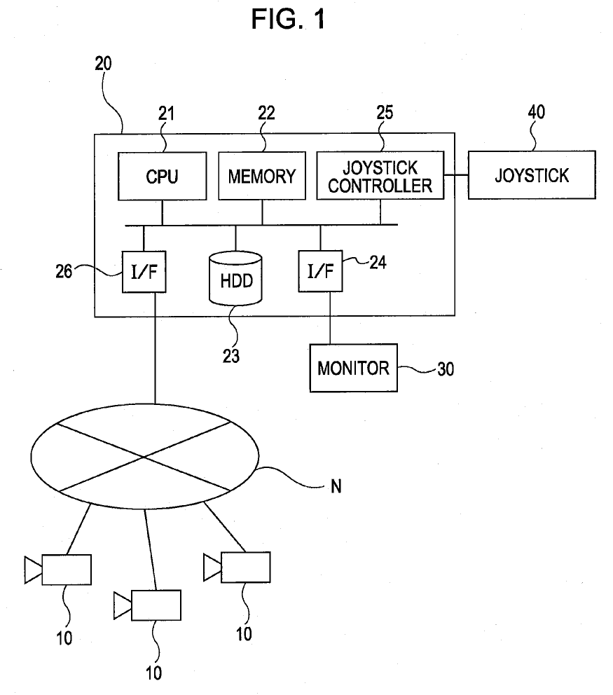

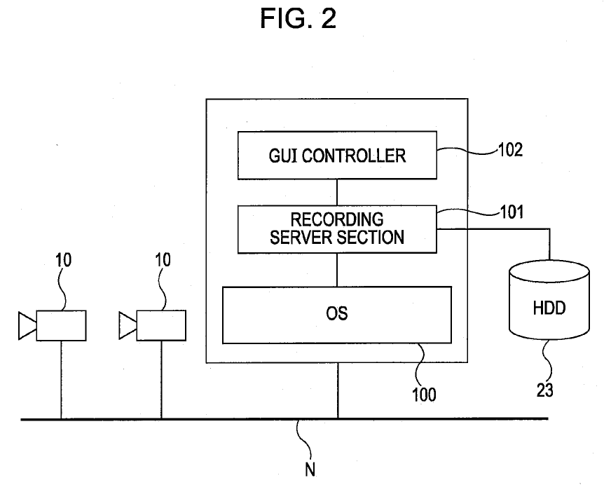

FIG. 1 is a schematic diagram illustrating a configuration of a video monitoring system according to an embodiment. FIG. 2 is a schematic diagram illustrating a configuration of a video monitoring program according to an embodiment.

As illustrated in FIG. 1, the video monitoring system of the present embodiment includes a camera 10 (or a plurality of cameras 10) connected to a network N, a monitoring device 20 connected to the network N, and a monitor (display means) 30 connected to the monitoring device 20. In the video monitoring system, a video image captured by the camera 10 is transmitted in a predetermined data format (e.g., Joint Photographic Experts Group (JPEG) or Moving Picture Experts Group phase 4 (MPEG-4) format) via the network N to the monitoring device 20 and can be displayed as a live video image on the monitor 30 connected to the monitoring device 20 and recorded in a hard disk drive (HDD) 23 serving as a recording means. It is also possible to retrieve a video image recorded in the HDD 23 and play back the retrieved video image.

To manage video images transmitted from the camera 10 via the network N, the monitoring device 20 includes a central processing unit (CPU) 21 serving as a control means for executing a video monitoring program, memory 22 such as random-access memory (RAM) serving as a work area for image processing or the like, and the HDD 23 for sequentially storing video images transmitted from the camera 10. The monitoring device 20 further includes a monitor interface 24 for connection to the monitor 30, a joystick controller 25 for controlling a joystick 40 serving as a remote control unit, and a network interface 26 serving as an input/output interface between the monitoring device 20 and the network N.

Referring to FIG. 2, the video monitoring program to be executed by the CPU 21 includes a recording server section 101 running on an operating system (OS) 100 and a graphical user interface (GUI) controller 102. The recording server section 101 performs processing for managing, along with camera identification numbers, dates and times of recording, and compression formats, video images transmitted from the camera 10, recording the video images in the HDD 23, and thus creating a video image database. Additionally, according to an instruction from the user, the recording server section 101 performs processing for retrieving a video image from the HDD 23 and playing back the retrieved video image.

The GUI controller 102 performs window control for displaying video images on the monitor 30 (see FIG. 1), controls assignment of video images to respective windows, controls display of various control buttons (icons) in the windows, and controls receipt of instructions entered by the user by using an input means, such as a mouse, keyboard, function buttons, or joystick.

With the system and program configurations described above, a video image captured by the camera 10 can be transmitted via the network N to the monitoring device 20 and displayed on the monitor 30. If a plurality of cameras 10 are connected to the network N, video images captured by the cameras 10 can be displayed in the respective windows, which are to be arranged on the monitor 30. It is also possible to use the entire screen of the monitor 30 to display a single window for a specific camera 10 only. If a camera 10 supports pan/tilt/zoom functions, it is possible to pan, tilt or zoom the camera 10 under the user's control and display the resulting video image.

Video images captured by the cameras 10 are sequentially recorded in the HDD 23 and organized into a video image database. Once the video image database is created in the HDD 23, it is possible to access the video image database from the monitoring device 20 to read a desired video image. At the same time, it is possible to access the video image database from an external personal computer connected to the same network N as the monitoring device 20 and refer to a desired video image.

In the video monitoring system of the present embodiment, the video monitoring program executed by the GUI controller 102 controls the joystick controller 25 so that an object to be operated with the joystick 40 can be selected according to an operation mode of the monitoring device 20.

The joystick 40 is typically used to control video capturing operation, such as pan/tilt/zoom operation, of any desired camera 10. In the present embodiment, when the monitoring device 20 is in a function setting mode for setting various functions, the joystick 40 can also be used to perform function setting.

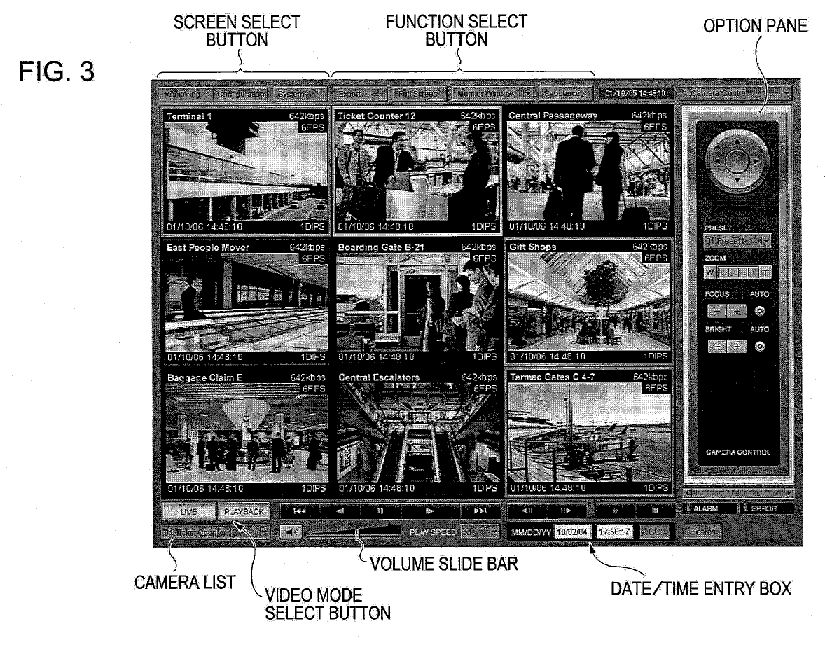

FIG. 3 illustrates a display example in which video images captured by a plurality of cameras are displayed on a monitor. In this example, video images captured by a plurality of cameras are displayed in respective windows and arranged vertically and horizontally. As shown, a total of nine windows which display respective video images captured by different cameras are arranged in a three by three matrix. This means that the video images captured by the nine cameras can be simultaneously monitored. The layout and number of windows to be displayed on the monitor are user selectable.

Screen select buttons and function select buttons are provided above the windows for displaying video images (hereinafter may also be referred to as “video display windows”). The screen select buttons are used to select content to be displayed in the area of the video display windows. The user selects “Monitoring” button to display video images captured by cameras, “Configuration” button to configure basic settings, and “System” button to configure system settings.

As for the function select buttons, the user selects “Export” button to output video images captured by cameras to an external recording medium, “Full Screen” button to display a selected window full screen, “Monitor Window” button to specify the layout (e.g., three by three matrix, two by two matrix, or the like) of the video display windows, and “Sequence” button to start or stop a monitor sequence for automatic screen selection.

There are provided, under the video display windows, video mode select buttons for selecting a display mode (i.e., live mode or playback mode) of a video display window, buttons for playback and recording operations, a camera list, a volume slide bar for adjusting volume, and a date/time entry box for retrieving recorded video images.

An option pane is displayed to the right of the video display windows. Content to be displayed in the option pane is selectable, with a pane select button, from “Camera Control”, “Active Camera List”, “Recorded Image List”, “Alarm Log”, “System Log”, “Alarm Output Status List”, “Sensor Input Status List”, “Moving Object Detection Status List”, and “Manual Trigger”.

Selecting “Camera Control” displays tools which allow control of camera functions, such as panning, tilting, zooming, focusing, and brightness adjustment of a video image displayed in a selected window. When “Active Camera List” is selected, a list of cameras in recording mode is displayed in the option pane. When “Recorded Image List” is selected, a list of recently recorded images is displayed in the option pane.

When “Alarm Log” is selected, an alarm-related log is displayed in the option pane. When “System Log” is selected, a log relating to system information and errors is displayed in the option pane. When “Alarm Output Status List” is selected, a current alarm output status is displayed in the option pane. When “Sensor Input Status List” is selected, a current sensor input status is displayed in the option pane.

When “Moving Object Detection Status List” is selected, current moving object detection information is displayed in the option pane. When “Manual Trigger” is selected, actions that can be manually triggered are displayed in the option pane.

The user can freely determine a video image captured by which camera is to be displayed in a specific window. That is, when the user selects a desired camera using a button for camera selection while a specific window is selected, a video image captured by the desired camera is displayed in the selected window.

Additionally, while a specific window displaying a video image is selected and the option pane displays appropriate tools for “Camera Control” described above, when the user selects, for example, an arrow button in the option pane, a camera corresponding to the selected window can be panned and tilted. Similarly, when the user selects, for example, a zoom button in the option pane, the displayed video image can be zoomed in and out.

To view a desired video image previously captured by a specific camera, the user first selects a window which currently displays a live video image captured by this camera. Then, the user enters a date and time in the date/time entry box to retrieve the desired video image. In the present embodiment, the date/time entry box is displayed under the lower right corner of the area of the video display windows. Therefore, the user can specify a date and time while maintaining the current state of the video display windows.

The user can simultaneously select multiple windows corresponding to cameras by which desired video images were previously captured. When multiple windows are selected, the date/time entry box allows the entry of a single date and time common to the multiple windows.

As described above, in addition to the functions of receiving video images from cameras and displaying the received video images, the monitoring device 20 has the functions of allowing the user to perform camera control and set various functions. These functions can be performed by selecting appropriate buttons (icons) in the option pain and menu items displayed on the monitor 30. Further, if the joystick 40 is connected as a remote control unit to the monitoring device 20, the above-described functions can also be performed by operating the joystick 40. Particularly in the present embodiment, by operating the joystick 40, the user can perform setting of various functions as well as camera control.

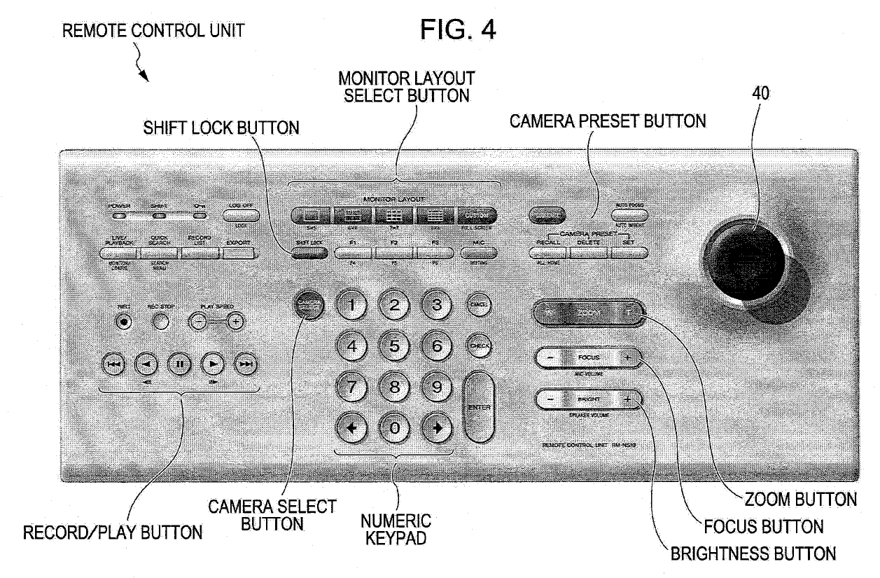

FIG. 4 is a schematic diagram illustrating a remote control unit, which primarily includes a joystick (40) and various buttons for selecting functions.

A joystick is a stick-like input device that can be tilted in any direction in the plane. According to the tilt direction and angle of the joystick, the direction and amount of control to be applied to an object can be adjusted. In the video monitoring system of the present embodiment, the shooting direction (i.e., panning and tilting) of a camera can be controlled according to the tilt direction of the joystick.

The joystick can be pivoted as well as tilted. For example, clockwise pivoting of the joystick can control a zoom-in operation and counterclockwise pivoting of the joystick can control a zoom-out operation.

Additionally, the control speed can be varied according to the tilt angle or the amount of pivoting of the joystick. That is, the control speed increases as the degree of tilting or pivoting of the joystick increases and decreases as the degree of tilting or pivoting of the joystick decreases.

The remote control unit also provides buttons, such as monitor layout select buttons, camera preset buttons, zoom/focus/brightness adjustment buttons, a video mode select button for selecting a display mode (i.e., live mode or playback mode) of a video display window, record/play buttons for recording and playback operations, a search button for retrieval, a numeric keypad with numeric keys used for camera selection and entry of various numerical settings, a shift lock button for switching the functions of buttons and the like, and function keys.

The monitor layout select buttons are used to select the layout of windows for displaying video images from cameras. For example, the user can select a desired layout from options, such as “FULL SCREEN”, “2×2”, “3×3”, “4×4”, and “CUSTOM”.

The camera preset buttons are used to immediately recall (display) a video image from a preset camera. The zoom/focus/brightness adjustment buttons are used to manually set zoom, focus, and brightness for a selected camera. The video mode select button is used to select between live and recorded video images.

The record/play buttons are used to perform operations, such as video recording, starting and stopping of playback, fast forward, and fast rewind. The search button is used to move a cursor to an entry box which allows the user to enter a specific date and time to recall a recorded video image.

As described above, the remote control unit not only provides hardware buttons which serves functions of various software buttons displayed on the monitor, but also provides a joystick which allows analog operation.

Next, operation performed when such a joystick is connected to the monitoring device will be described. First, when the monitoring device is in a camera control mode, panning, tilting, and zooming of a camera can be controlled with a joystick. That is, the user can control panning, tilting, and zooming of a preselected camera by operating the joystick.

When the monitoring device is in a function setting mode for setting various functions, the joystick allows the user to move a pointer displayed on the monitor and select a menu item from a list. That is, by operating the joystick, the user can change the position of a predetermined pointer displayed on the monitor.

For example, on the monitor of FIG. 3, a pointer corresponding to the frame of any of the windows in a three by three matrix is provided. The user moves this pointer to select a specific window. In the present embodiment, the pointer can be moved by operating the joystick. That is, by tilting the joystick from side to side and up and down, the user can move the pointer among the windows according to the tilt direction of the joystick.

Also, when a function for displaying a list is selected, the user can move the pointer over the displayed list by operating the joystick.

Here, a mode change for changing the operation of the joystick can be made by a predetermined button operation. For example, when the shift lock button in the remote control unit is not pressed, the monitoring device is in a normal camera control mode which allows the user to perform camera control with the joystick. On the other hand, when the shift lock button is pressed, the monitoring device enters a function setting mode which allows the user to perform pointer control with the joystick.

Alternatively, a mode change for changing the operation of the joystick may be made only while a predetermined button is held down. In the example described above, only while the shift lock button is held down, the monitoring device is in the function setting mode which allows the user to move the pointer and select a menu item from a displayed list. Then, when the user releases the shift lock button, the monitoring device returns to the camera control mode which allows the user to perform camera control with the joystick.

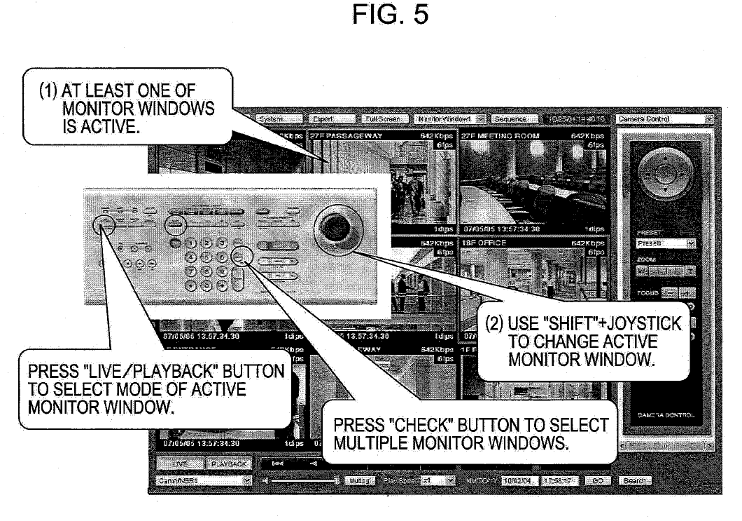

FIG. 5 is a schematic diagram illustrating a first example of joystick operation. In this example, at least one of nine windows displayed in a three by three matrix is active. Whether a specific window is active can be recognized by the color of a frame around the window. Pressing the shift lock button allows the user to change the active window with the joystick. Also, pressing a check button allows selection of multiple windows.

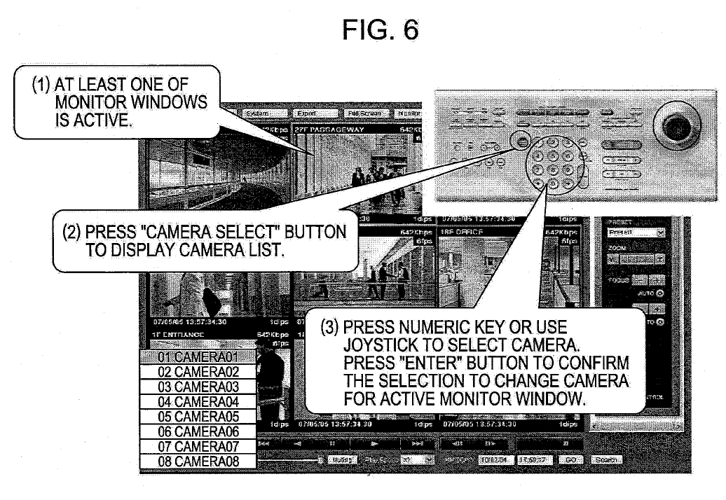

FIG. 6 is a schematic diagram illustrating a second example of joystick operation. FIG. 6 illustrates a state in which, when a camera select button is pressed, a camera list under the lower left corner of the area of the video display windows pops up. When the user tilts the joystick up and down with the camera list displayed, a pointer for selecting a specific camera on the camera list is moved according to the tilt direction of the joystick. Alternatively, it is possible to directly select a camera by selecting a numeric key corresponding to a number to the left of the name of the camera.

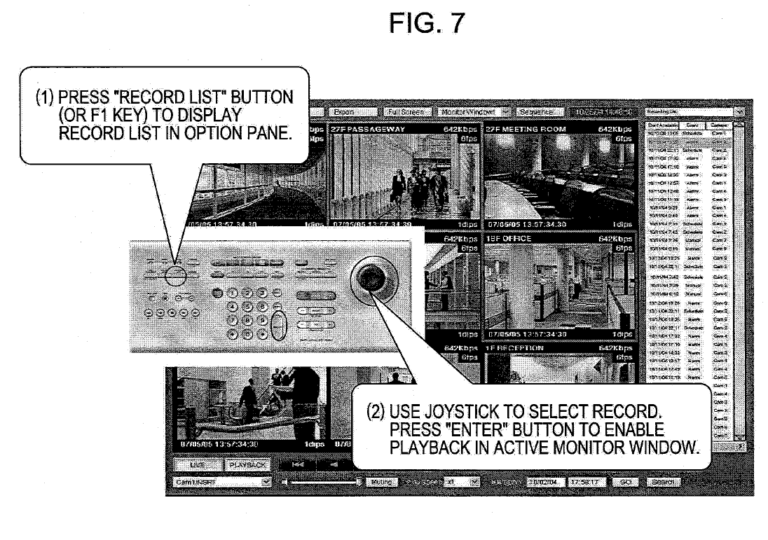

FIG. 7 is a schematic diagram illustrating a third example of joystick operation. FIG. 7 illustrates a state in which, when a record list button is pressed, a record list pops up in the option pane to the right of the video display windows. When the user tilts the joystick up and down with the record list displayed, a pointer for selecting a specific record on the record list is moved according to the tilt direction of the joystick. Then, when “ENTER” button is pressed with a desired record selected, a video image corresponding to the selected record is displayed in an active window.

In another exemplary operation, if “PLAY” button of record/play buttons for recording and playback operations is kept held down, playback speed can be adjusted with the joystick. That is, when a video image captured by a predetermined camera is to be played back, the user first specifies a date, time, and the like and presses “PLAY” button. This starts playback of a video image at a normal speed. Then, when “PLAY” button is kept held down during playback, an adjustment mode which allows the user to adjust the playback speed with the joystick can be selected only while “PLAY” button is held down. For example, if the user tilts the joystick to the right while “PLAY” button is held down, the playback speed increases according to the tilt angle of the joystick. On the other hand, if the user tilts the joystick to the left while “PLAY” button is held down, the playback speed decreases according to the tilt angle of the joystick.

As describe above, since an object to be controlled with a joystick can be changed by mode selection, the user can not only simply perform camera control with a joystick, but also can specify various settings with the joystick and can achieve quick operation.

The correspondences between various modes and objects to be controlled with the joystick are not limited to those described above.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A video monitoring system comprising:
a camera connected to a network;
recording means for recording, via the network, video images captured by the camera;
display means for displaying video images captured by the camera;
control means for controlling display of video images on the display means; and
a joystick controller changing the operation of a joystick according to a control mode selected by the control means,
wherein the joystick controller performs control such that when the joystick controller is controlled in a camera control mode by the control means, a video capturing operation of the camera is controllable with the joystick, and when the joystick controller is controlled in a function setting mode by the control means, the operation of a pointer displayed on the display means or selecting operation for selecting a list item is controllable with the joystick.

2. The video monitoring system according to claim 1, wherein the joystick controller adjusts the control speed thereof according to the amount of operation of the joystick.

3. The video monitoring system according to claim 1, wherein the joystick controller changes an object to be operated with the joystick only while a predetermined button is held down.

4. A video monitoring program executed by a video monitoring system including a camera connected to a network; recording means for recording, via the network, video images captured by the camera; display means for displaying video images captured by the camera; control means for controlling display of video images on the display means; and a joystick controller changing the operation of a joystick according to a control mode selected by the control means, the video monitoring program comprising the step of:
performing control such that when the joystick controller is controlled in a camera control mode by program processing carried out by the control means, a video capturing operation of the camera is controllable with the joystick, and when the joystick controller is controlled in a function setting mode by program processing carried out by the control means, the operation of a pointer displayed on the display means or selecting operation for selecting a list item is controllable with the joystick.

5. A video monitoring system comprising:
a camera connected to a network;
a recording unit recording, via the network, video images captured by the camera;
a display unit displaying video images captured by the camera;
a control unit controlling display of video images on the display means; and
a joystick controller changing the operation of a joystick according to a control mode selected by the control unit,
wherein the joystick controller performs control such that when the joystick controller is controlled in a camera control mode by the control unit, a video capturing operation of the camera is controllable with the joystick, and when the joystick controller is controlled in a function setting mode by the control unit, the operation of a pointer displayed on the display unit or selecting operation for selecting a list item is controllable with the joystick.

6. A video monitoring program executed by a video monitoring system including a camera connected to a network; a recording unit recording, via the network, video images captured by the camera; a display unit displaying video images captured by the camera; a control unit controlling display of video images on the display unit; and a joystick controller changing the operation of a joystick according to a control mode selected by the control unit, the video monitoring program comprising the step of:
performing control such that when the joystick controller is controlled in a camera control mode by program processing carried out by the control unit, a video capturing operation of the camera is controllable with the joystick, and when the joystick controller is controlled in a function setting mode by program processing carried out by the control unit, the operation of a pointer displayed on the display unit or selecting operation for selecting a list item is controllable with the joystick.
